(19) United States
(12) Patent Application Publication
(10) Pub. No.: US 2004/0205824 A1
(43) Pub. Date: Oct. 14, 2004

(54) Web home security system

(75) Inventor: James Tsai, Chung-Ho City (TW)

Correspondence Address: BACON & THOMAS, PLLC, 625 SLATERS LANE, FOURTH FLOOR, ALEXANDRIA, VA, 22314

(73) Assignee: CHIC TECHNOLOGY CORP., Chung-Ho City (TW)

(21) Appl. No.: 10/410,246

(22) Filed: Apr. 10, 2003

(51) Int. Cl. H04N 7/18

(52) U.S. Cl. 725/105; 348/143

(57) ABSTRACT

The present invention relates to a Web home security system especially one suitable for families and small enterprises using embedded IP (Internet Protocol) skill to form a solid and fireproof security system. The present invention mainly comprises a system PC with Web server, Internet, several wireless sensors, residential gateway, Web camera, PC and embedded IP skill, Web communicating interface RJ-45 and IEEE 802.11b WLAN port. Hence, the present invention provides a convenient way for distant surveillance and alarm of residential areas, smart-type office buildings and factories and, simultaneously, enjoys wireless on-line connection.

### TECHNICAL RANGE

The present invention relates to a Web home security system especially one suitable for families and small enterprises using embedded IP (Internet Protocol) skill to form a solid and fireproof security system.

### INVENTION BACKGROUND

The use of home network is gradually increasing nowadays subject to improvement in network equipment and chip business. However, due to several different factors such as information, audio, entertainment, control and so on, some unrelated devices are also connected and gathered in a home network, thus making it necessary to develop new network skills in order to meet such demand.

The demand for this kind of embedded network connection mainly faces a system on chip connecting wireless local area network (WLAN), Ethernet and other area network media arranged inside such that some parts of WLAN can be adjusted to modem and chip gateway stand for new energy and high adjustment of communicating processor.

### Content

The present invention relates to a Web home security system mainly using a network camera, several wireless sensors, PC and residential gateway to form an information center going through Internet to link to distant computer for remote control and home protection.

The present invention relates to a Web home security system consisting of IEEE 802.11b WLAN port designed with WLAN for convenient unlimited wireless on-line connections for residential and office use.

The present invention relates to a Web home security system using embedded IP skill and Web communicating interface RJ-45 for application of residential gateway in order to provide a mutual communicating platform amongst all kinds of residential Web skills and for smooth function and control.

### Mode for Carrying out Invention

With reference to FIG. 1 showing a view of the present invention, the present invention mainly comprises a system PC with Web server 11, Internet 12, several wireless sensors 13, residential gateway 14, Web camera 15, PC 16, especially using embedded IP skill, Web communicating interface RJ-45 and IEEE 802.11b WLAN port.

With further reference to FIG. 1, the present invention assembles Web camera 15, several wireless sensors 13, PC 16 and residential gateway 14 to form a residential information gathering center with the residential gateway 14 principally. It then passes through Internet 12 to link to system PC with Web server 11 found at a distance in order to achieve purpose of remote-controlling for home security and protection.

The present invention mentioned above consists of an IEEE 802.11b WLAN port designed with a WLAN (Wireless Local Area Network) for convenient unlimited on-line connections.

The present invention mentioned above uses embedded IP skill and Web communicating interface RJ-45 for application of residential gateway in order to provide a mutual communicating platform amongst all kinds of residential Web skills and for smooth function and control.

### DESCRIPTION OF DRAWINGS

FIG. 1 shows a view of the present invention.

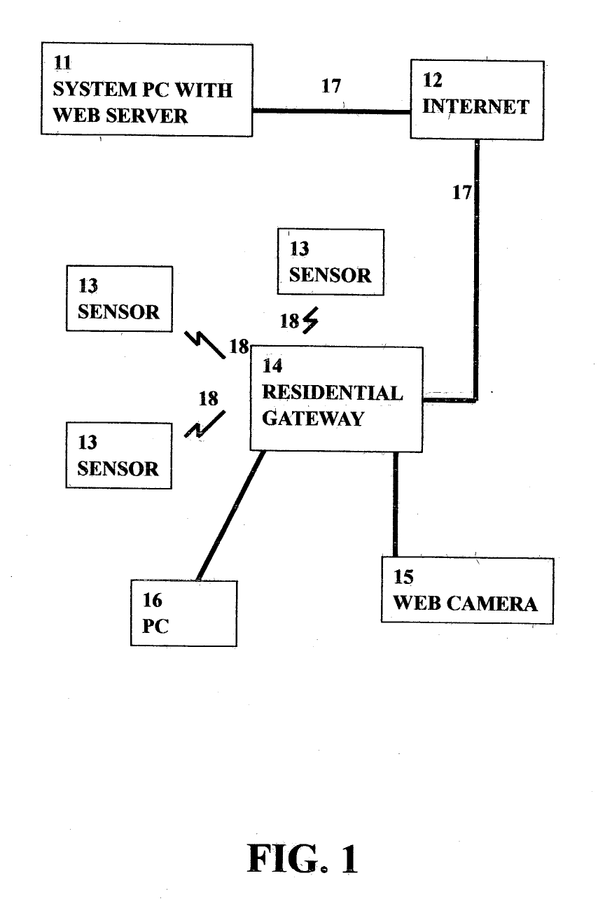

### NUMERICALS

11—system PC with Web server

12—Internet 13—several different sensors

14—residential gateway 15—Web camera

16—PC 17—Web line 18—wireless signal

1. A “Web home security system” mainly comprises a system PC with Web Server, Internet, several wireless sensors, residential gateway, Web camera, PC and embedded IP(Internet Protocol) skill, Web communicating interface RJ-45 and IEEE 802.11b WLAN port, as characterized.

2. As mentioned in claim 1 of a “Web home security system” mainly using a Web camera, several wireless sensors, PC and residential gateway to form a residential information gathering center with the residential gateway principally, it then pass through Internet to link to distant system PC with Web server found at a distance in order to achieve purpose of remote-controlling for home security and protection.

3. As mentioned in claim 1 of a “Web home security system”, the present invention consists of an IEEE 802.11b WLAN port for convenient unlimited on-line connections at home or at the office.

4. As mentioned in claim 1 of a “Web home security system”, the present invention uses embedded IP skill and Web communicating interface RJ-45 for application of residential gateway in order to provide a mutual communicating platform amongst all kinds of residential Web skills and for smooth function and control.
